(19) United States
(12) Patent Application Publication
(10) Pub. No.: US 2015/0050114 A1
(43) Pub. Date: Feb. 19, 2015

(54) READ-THROUGH CARD ACCESS TAB

(71) Applicant: Cheryl A. Conroy, Chandler, AZ (US)

(72) Inventor: Cheryl A. Conroy, Chandler, AZ (US)

(21) Appl. No.: 13/967,995

(22) Filed: Aug. 15, 2013

(51) Int. Cl. G09F 3/10

(52) U.S. Cl. CPC G09F 3/10; B32B 38/0004
USPC 414/800; 294/212; 156/226

(57) ABSTRACT

A removable and positionable gripping element for attaching to cards has:
f) two opposed surfaces having pressure-sensitive adhesive on the opposed surfaces;
g) at least one of the opposed surfaces, and preferably both of the opposed surfaces being translucent or transparent and having a length;
h) the two opposed surfaces being joined at a top end;
i) attached to the top end of the two opposed surfaces at a point of attachment is a gripping element having a length; and
j) the point of attachment being flexible.

A method of manufacturing the gripping element is accomplished by lamination then conversion of layers. The element is simply positioned over an edge of the card to provide a semi-permanent handle for easing the removal of the card from a pocket, slot or window.

### BACKGROUND OF THE ART

1. Field of the Invention

The present invention relates to the field of cards, card holders and access to cards in card retention devices. A particular area of practice includes removal of identification cards or credit cards or any other frequently used cards from purses or wallets using individualized gripping elements secured to the cards.

2. Background of the Art

The need for ready access to credit cards and identification cards (e.g., driver licenses, credit/debit cards, gift cards, membership cards, employment cards, etc.) has become a staple of modern life. For simple banking and purchase transactions, it is often necessary to provide multiple forms of identification and verification.

In many environments, such as boarding aircraft or in teller lanes at banks or retail store checkout lines, the natural urge for speed and the difficulty in finding and removing individual cards can result in spillage of multiple cards, frustration by the primary card user, and irritation from others in the line behind the primary card user. Simplifying access to desired individual cards would be advantageous for all parties involved.

Much effort has been placed on the protection (against wear or markings) of such identification cards or credit cards, as shown by the following references. These methods do nothing to simplify access to individual cards, and by increasing the thickness of the individual cards, any process of removal of individual cards from carriers can be made more difficult.

U.S. Pat. No. 4,711,347 (Drexler) describes a protective envelope having an adhesive flap which lifts open to expose a data storage area of a data card, allowing data to be read while the card remains protected in the envelope. The flap may be then closed over and re-adhered to the card. The envelope comprises a base and a cover panel bonded at three edges to form a pocket for card storage. The cover panel is made up of a pair of fixed edge stripes bonded to respective opposed side edges of the base and a liftable flap bonded to a back edge of the base. Envelope materials are preferably a transparent, flexible plastic, but only the flap need be flexible. The flap may extend beyond and fold over a front edge of the base and adhere to an underside of the base. An alternative embodiment of the envelope provides two flaps, bonded to respective front and back edges of a base, which open from the center.

U.S. Pat. No. 4,322,001 (Hurley) describes a case for protecting a collectible article, such as a baseball card, photograph, or the like. The article is enclosed within the protective case which comprises a base and a cover. Both the base and cover are preferably constructed from transparent elastic material, such as clear polyvinyl plastic. The base includes a peripheral boss which encircles the article when the article is placed on the base, and the cover includes a downturned edge which interlocks with the boss when the cover is applied to the base. Preferably, the boss of the base is angled outwardly, and the downturned edge of the cover is angled inwardly, so that the base and cover snap fit together due to the elasticity of the material used for constructing the base and cover, thereby sealing the article within the protective case. Preferably, a flange surrounds the boss of the base, and another flange surrounds the downturned edge of the cover, for increasing the rigidity of the protective case. The flanges of the base and cover along one side of the protective case preferably extend outwardly and form tabs which facilitate opening the protective case after the base and cover are joined together. Other features are also disclosed.

U.S. Pat. No. 3,994,328 (Reis) describes a billfold or wallet for carrying a plurality of credit cards or the like in readily accessible position including a removable folded flexible flap member protecting the cards. The wallet includes a plastic liner forming a plurality of separate pockets for receiving credit cards therein and a removable flexible flap covering the pockets in order to protect the credit cards located therein from abrasive wear and to prevent the credit cards from inadvertently slipping out of the wallet. The flexible flap is made from a thin, transparent plastic material so that the cards may be easily selected, and the flap is removably secured in such a manner as to facilitate its removal or insertion of a replacement flexible flap.

U.S. Pat. No. 3,838,808 (Schroeder) discloses an envelope produced from an envelope blank for safely mailing credit cards in a self-contained, slotted pocket. The envelope blank has side flaps or extended seams on opposing ends of the rectangular face panel of the envelope blank with at least one of the side flaps or extended seams having a slot therein.

U.S. Pat. No. 7,690,608 (Huber) describes a mounting assembly that is provided for securing objects to a substrate in a manner that permits the objects to be removed from the mounting assembly and from the substrate. The mounting assembly includes a planar sheet-like holder with opposite front and rear faces. A repositionable adhesive is applied across the entire rear face of the holder, and the holder is removably disposed on a release liner. A generally U-shaped cut is formed in the holder to define a flap. The flap can be repositionably attached to the object, while remaining portions of the holder can be repositionably secured to a substrate.

These disclosures do not address the problems of individual card removal from storage areas such as wallets, purses, card holding books and the like.

### SUMMARY OF THE INVENTION

A removable and positionable gripping element for attaching to cards has:
a) two opposed surfaces having pressure-sensitive adhesive on the opposed surfaces;
b) at least one of the opposed surfaces being translucent or transparent and having a length, with an option of both opposed surfaces being transparent.
c) the two opposed surfaces; being joined at a top end;
d) attached to the top end of the two opposed surfaces at a point of attachment is a gripping element having a length; and
e) the point of attachment being flexible.
   A methods of manufacturing the gripping element is accomplished by lamination then conversion of layers. The element is simply positioned over an edge of the card to provide a semi-permanent handle for easing the removal of the card from a pocket, slot or window.

### BRIEF DESCRIPTION OF THE FIGURES

FIG. 1 shows an exploded perspective view of the minimum three elements needed to construct the card-gripping element described in the present technology.

FIG. 2 shows a side view of a card-gripping element within the scope of the present technology.

### DETAILED DESCRIPTION OF THE INVENTION

A removable and positionable gripping element for attaching to cards may have certain features and components. Among the features and components may be
a) two opposed surfaces having pressure-sensitive adhesive on the opposed surfaces;
b) at least one of the opposed surfaces is translucent or transparent, with an option of both opposed surfaces being transparent.
   The opposed surfaces may be any functional length sufficient to allow adhesion to the surfaces of cards (e.g., credit cards and identification cards, such as drivers licenses, etc.) with sufficient strength that the cards may be pulled or tugged at parallel to the opposed surfaces without the surfaces being removed. This usually takes a balance between the strength of the adhesive and the length of the surfaces along which the adhesive grips the cards. As pressure-sensitive adhesives are being used, a general (but not exclusive) range of contact between the adhesive and the card surfaces would be about a length of between 5 and 60 millimeters. A shorter length (e.g., 3 mm) will work, but not be robust. A longer length (e.g., 10 cm) is basically redundant, and will work well, but wastes materials.
c) the two opposed surfaces being joined at a top end;
   The top end may be (for example) a fold line on a single piece of pressure-sensitive adhesive-coated sheet material (e.g., translucent of transparent film or paper), or may be a bond line where two opposed sheets of adhesive coated surfaces (one of which at least is translucent or transparent).
d) attached to the top end of the two opposed surfaces at a point of attachment is a gripping element between 4 and 40 millimeters;
   Again, the size of the gripping element is functional and ergonomic. If the element is small (e.g., 2-4 millimeters), it will be harder to see and grip, but can still function. If the element is too long (e.g., up to 100 millimeters), it will be out of place and even annoying within the card carrier. Even though the gripping element may fold down to lie along a surface of the card within a sleeve or window, a large size is unnecessary and wasteful of materials. The gripping element may be decorative beyond merely providing distinctions between individual types of cards to which they are attached. Although square or rectangular shapes are easiest to manufacture, any other shape may be punched or cut from materials to provide a decorative appearance that is still functional. The surfaces or depth of the material used to form the gripping element may have pictures, paintings, patterns, materials, beads, sparkles stones or other surface-type or appearance-type modifications to assist in commercializing the product without adversely impacting the functionality of the device.
e) the point of attachment being flexible.
   It is undesirable for the point of attachment to be brittle, as the gripping element will be used manually and the angle of force applied to it will vary, even while a card is partially within a sleeve or window. A brittle connection would promote breaking of the grip off the opposed surfaces, which is undesirable. The use of common tape materials for the opposed surfaces (e.g., 0.05 to 10 mils) and/or the use of a flexible gripping material (polymeric film, decorative polymeric film, fabric, metalized polymeric film and the like, will usually provide flexibility at the end of the gripping element where it overlays the opposed surfaces.

Any pressure-sensitive adhesive may be used.

Pressure-sensitive adhesives are art recognized as a standard class of materials. These are adhesives which in dry (substantially solvent free except for residual solvent) form are aggressively and permanently tacky at room temperature (e.g., 15.degree. to 25.degree. C.) and firmly adhere to a variety of dissimilar surfaces upon mere contact without the need for more than manual pressure. They require no activation by water, solvent or heat in order to exert a strong adhesive holding force towards such materials as paper, cellophane, glass, wood and metals. They have a sufficiently cohesive holding and elastic nature so that, despite their aggressive tackiness, they can be handled with the fingers and removed from smooth surfaces without leaving a substantial residue (cf. Test Methods for Pressure-Sensitive Tapes, 6th Ed., Pressure Sensitive Tape Council, 1953). Pressure-sensitive adhesives and tapes are well known, and the wide range and balance of properties desired in such adhesives has been well analyzed (cf. U.S. Pat. No. 4,374,883; and “Pressure-Sensitive Adhesives” in Treatise on Adhesion and Adhesives Vol. 2, “Materials”, R. I. Patrick, Ed., Marcel Dekker, Inc., N.Y., 1969). The various materials and compositions useful as pressure-sensitive adhesives are available commercially and are thoroughly discussed in the literature (e.g., Houwink and Salomon, Adhesion and Adhesives, Elsevier Publ. Co., Amsterdam, Netherlands, 1967; Handbook of Pressure-Sensitive Adhesive Technology, Donates Satas, Ed., VanNostrand Reinhold Co., N.Y., 1982).

Pressure-sensitive adhesives are generally chemically composed of rubber-resin materials, acrylic resins, polyurethane resins, silicone resins, and the like. Amongst the various patent literature describing compositions and improvements in pressure-sensitive adhesive formulations are U.S. Reissue Pat. No. 24,906; U.S. Pat. No. 2,652,351; U.S. Pat. No. 3,740,366; U.S. Pat. No. 3,299,010; U.S. Pat. No. 3,770,708; U.S. Pat. No. 3,701,758; U.S. Pat. No. 3,922,464; U.S. Pat. No. 3,931,087; U.S. Pat. No. 4,012,560; U.S. Pat. No. 4,077,926; U.S. Pat. No. 4,387,172; U.S. Pat. No. 4,418,120; U.S. Pat. No. 4,629,663; and the like. These classes of rubber resin, acrylic, silicone, and polyurethane pressure-sensitive adhesives as well as any other pressure-sensitive, thermally-activatable, solvent-activatable, or water-activable adhesives are generally useful in the present invention.

U.S. Pat. No. 5,571,617 is an example of a microspherical pressure-sensitive adhesive that is commercially available as a Post-It repositionable adhesive. Processes for preparing solid microspheres are also disclosed. Methods for applying pressure-sensitive adhesives to surfaces, and particularly microspherical pressure-sensitive adhesives are known in the art as exemplified by U.S. Pat. Nos. 5,972,113; 5,958,135; 5,939,161; 5,916,630; 5,891,530; and 5,849,358. All references cited herein are incorporated by reference in their entirety for the full scope of their technical disclosures.

The elements of the present technology have the opposed surfaces of the same or different materials. For simplicity, at least one or both of the opposed surfaces are transparent or translucent, especially to white light. it is preferred to have both surfaces transparent or translucent, in case there is information on both sides of the card which may be mechanically read or which needs visual inspection. This type of transparency or translucency is desirable so that the data on the card is not unnecessarily obscured or hidden, so that the card can be viewed with it natural color and clarity, even to a point of remaining scannable by cameras or imaging systems. The simplest structure is where the two opposed surfaces are a single strip of adhesive tape folded at a fold line with adhesive faces facing each other. The structural surface supporting the adhesive may be translucent or transparent paper or polymeric film such a synthetic or natural polymers or resins, including but not limited to polyvinyl resins, polyesters, polyethers, acrylic polymers, silicone polymers, polyamides, polyolefins, acetates, and the like.

Again, for structurally reasons the gripping element extends over the fold line or join line between the two opposed surfaces. The generally preferred distance for overlap is about a distance of at least 2 millimeters. The gripping element is preferably visually distinguishable from the two opposed surfaces, as by its being colored, less translucent or opaque. In commercial formats of the element before use, a release layer, and preferably a two-sided release liner is positioned between the two opposed surfaces.

The two opposed faces may be secured on opposite sides of a card, such as an identification card or financial card (e.g., debit card, charge card, patron card, or credit card),one opposed face of the element on only one side of the identification or credit card, with preferably each of the opposed faces on one of the opposed sides of the card and the identification or credit card is held within a sleeve or window with the gripping element extending out of an opening in the sleeve or window that is large enough for removal of the identification or credit card from the sleeve or window. The sleeve or window may be a slot in a bank of slots within a wallet, for example. The gripping element attached to individual cards may have individual shapes, colors or patterns so that the correct card may be selected. For example, if an individual keeps all cards in a bank of slots in a wallet, the most frequently used cards (only or all of the cards) may have individual and differing patterns on the gripping element. For example, the colors or symbols associated with a particular State may be for the Driver License, a dollar sign for the primary credit card, and a cent sign for a secondary credit card. A golf ball or workout image or pattern may be used for a club membership card. Character images (superhero, cartoons, personalities, etc.) or designs depicting hobbies, special interests or favorite teams may also be used on the grips for identification of particular cards.

The elements may be mass manufactured by a simple method manufacturing the element by:
a) providing a sheet of support film having only one face that is coated with pressure-sensitive adhesive and a second uncoated face;
b) adhering a sheet of gripping material along a line on the second face of the support film;
c) folding the gripping material and the sheet of support film so that the opposed surfaces are formed; and
d) cutting both the gripping element and the opposed surfaces to form individual elements.
   The aligning, folding and other steps may be performed in various orders or simultaneously by conventional or specially designed apparatus.

Reference to the Figures will further explain, describe and enable practices within the scope of the present technology.

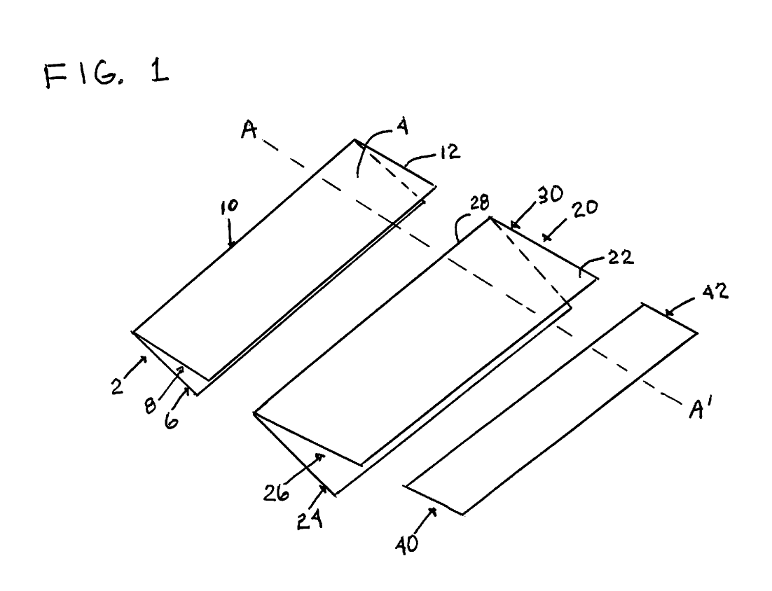

FIG. 1 shows an exploded perspective view of the minimum three elements 2, 20 and 40 needed to construct the card-gripping element described in the present technology. The gripping layer 2 is shown with a top surface 4 and a bottom surface 6 which creates an enclosing area or gripping pocket 8. The pocket 8 is formed by folding the gripping layer 2 along line 10. An adhesive layer (not shown) may be applied or be present on the interior surfaces of the top surface 4 and the bottom surface 6 that define the pocket 8. The edge 12 of the gripping element 2 defines a length of maximum extension of the gripping element over the card-gripping and card-overlaying element 20.

The card-gripping and card-overlaying element 20 has a top surface 22 and bottom surface 24 that in opposition form the second enclosing area or second pocket 26. The second pocket 26 of the card-gripping and card-overlaying element 20 may be formed by the fold line 28 in the card-gripping and card-overlaying element 20. The edge 30 of the card-gripping and card-overlaying element 20 defines a length of maximum extension of the card-gripping and card-overlaying element 20 over an optional, but preferred release liner 40. The outside of the top surfaces 22 and 24 (facing away from the pocket 26) are overlain and in secured contact (adhesive, fusion, mechanically fixed, etc.) within the pocket 8 of the gripping layer 2. The length of edge 30 must be greater than the length of edge 12 if the fold line 28 extends completely into the gripping layer 2 up to or near the fold line 10 of the gripping element. If there is a gap between fold lines 28 and 10, the length of edge 30 may be same or less than the length of edge 12. The length of edge 42 may be less than, the same size or greater than the length of edge 20 although it is preferred or length 42 to be the same size r longer than the length of edge 20.

In manufacturing a gripping element, one optional method is to provide lengths of overlain and folded release liners 40 within the second pocket 26 of folded card-gripping and card-overlaying elements 20 in turn within the pocket 8 of the folded gripping layer 2. After a length of this three-element (2, 20 and 40) has been constructed, the composite may be converted into final elements by cutting the composite, as along line A-A′ in FIG. 1.

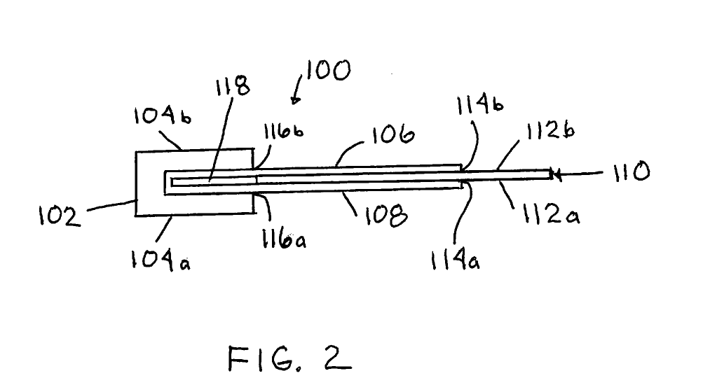

FIG. 2 shows a side view of a card-gripping element 100 within the scope of the present technology. The FIG. 2 shows the gripping element 100 constructed with the preferred two-side coated release liner 110 nested between opposed folded or joined adhesive layers 106 and 108. These two opposed adhesive layers 106 and 108 are secured between sides 104a and 104b of the gripping layer 102. The sides 104a and 104b of the gripping layer 102 may be decorated, but preferably are colored or patterned to differentiate them from the transparent or translucent adhesive layers 106 and 108 so that the gripping layer 102 may be visually recognized by a user. A gap 118 within the adhesive-bearing layers 106 and 108 may or may not be maintained, as pressure on the surfaces 104a and 104b may compress some of this gap 118 and adhesive on the inner surfaces 112a and 112b of the adhesive-bearing layers 108 and 106, respectively, may adhere together and remove some or all of the gap 118. The release liner 110 is shown with preferred release coatings on surfaces 112a and 112b, although only one-side coating may be used.

Similarly, an adhesive for securing the gripping layer 102 to the exterior faces of the folded or joined faces 106 and 108 of the adhesive layer may be present on inner surfaces of the gripping layer faces 104a and 104b or applied to outer surfaces of adhesive layer elements 106 and 108 to form an adhesive line 116a and 116b between the sides 104a and 104b and the adhesive layers 108 and 106, respectively along lines 116a and 116b, respectively. Although it is preferred for the adhesive along lines 114a and 114b to be pressure-sensitive adhesives, even though the adhesive along lines 116a and 116b may be pressure-sensitive (so that the adhesive-bearing layers 106 and 108 might be replaceable, that adhesive material along lines 116a and 116b may be more permanent, and need not be pressure-sensitive.

The gripping element may typically be between 2 and 8 cm (although larger gripping elements may be easily used), with the gripping layer usually at least 5 mm to allow for ease of gripping. Although specific materials and measurements are used in these descriptions, one skilled in the art will appreciate that variations and alternatives may be used in practicing the generic scope of the present technology.

What is claimed:

1. A removable and positionable gripping element for attaching to cards comprising:
a) two opposed surfaces having pressure-sensitive adhesive on the opposed surfaces;
b) at least one of the opposed surfaces being translucent or transparent and having a length;
c) the two opposed surfaces being joined at a top end;
d) attached to the top end of the two opposed surfaces at a point of attachment is a gripping element having a length; and
e) the point of attachment being flexible.

2. The element of claim 1 wherein the pressure-sensitive adhesive comprises a repositionable microspherical adhesive.

3. The element of claim 1 wherein both of the opposed surfaces are transparent or translucent to white light.

4. The element of claim 1 wherein the two opposed surfaces are a single strip of translucent or transparent adhesive tape folded at a fold line with adhesive faces facing each other.

5. The element of claim 3 wherein the two opposed surfaces are a single strip of translucent or transparent adhesive tape folded at a fold line with adhesive faces facing each other.

6. The element of claim 5 wherein the gripping element extends over the fold line for a distance of at least 2 millimeters.

7. The element of claim 6 wherein the gripping element is visually distinguishable from the two opposed surfaces.

8. The element of claim 6 wherein the gripping element is opaque.

9. The element of claim 1 wherein a two-sided release liner is positioned between the two opposed surfaces.

10. The element of claim 5 wherein a two-sided release liner is positioned between the two opposed surfaces.

11. The element of claim 7 wherein a two-sided release liner is positioned between the two opposed surfaces.

12. The element of claim 1 wherein the two opposed faces are secured on opposite sides of an identification or credit card, one opposed face of the element on only one side of the identification or credit card, and the identification or credit card is held within a sleeve or window with the gripping element extending out of an opening in the sleeve or window that is large enough for removal of the identification or credit card from the sleeve or window.

13. The element of claim 3 wherein the two opposed faces are secured on opposite sides of an identification or credit card, one opposed face of the element on only one side of the identification or credit card, and the identification or credit card is held within a sleeve or window with the gripping element extending out of an opening in the sleeve or window that is large enough for removal of the identification or credit card from the sleeve or window.

14. The element of claim 5 wherein the two opposed faces are secured on opposite sides of an identification or credit card, one opposed face of the element on only one side of the identification or credit card, and the identification or credit card is held within a sleeve or window with the gripping element extending out of an opening in the sleeve or window that is large enough for removal of the identification or credit card from the sleeve or window.

15. The element of claim 6 wherein the two opposed faces are secured on opposite sides of an identification or credit card, one opposed face of the element on only one side of the identification or credit card, and the identification or credit card is held within a sleeve or window with the gripping element extending out of an opening in the sleeve or window that is large enough for removal of the identification or credit card from the sleeve or window.

16. The element of claim 7 wherein the two opposed faces are secured on opposite sides of an identification or credit card, one opposed face of the element on only one side of the identification or credit card, and the identification or credit card is held within a sleeve or window with the gripping element extending out of an opening in the sleeve or window that is large enough for removal of the identification or credit card from the sleeve or window.

17. A method of providing a removal means for an identification or credit card from a sleeve or window comprising removing the release liner from between the two opposed surfaces of the element of claim 9, placing one opposed surface against a first front side of an identification or credit card and placing a second opposed surface against a second back side of the identification or credit card to grip the identification or credit card, inserting the gripped identification or credit card into the sleeve or window through a side opening in the sleeve or window so that the gripping element extends out of the side opening to form a removal means for the identification or credit card from the sleeve or window.

18. A method of providing a removal means for an identification or credit card from a sleeve or window comprising removing the release liner from between the two opposed surfaces of the element of claim 10, placing one opposed surface against a first front side of an identification or credit card and placing a second opposed surface against a second back side of the identification or credit card to grip the identification or credit card, inserting the gripped identification or credit card into the sleeve or window through a side opening in the sleeve or window so that the gripping element extends out of the side opening to form a removal means for the identification or credit card from the sleeve or window.

19. A method of providing a removal means for an identification or credit card from a sleeve or window comprising removing the release liner from between the two opposed surfaces of the element of claim 11, placing one opposed surface against a first front side of an identification or credit card and placing a second opposed surface against a second back side of the identification or credit card to grip the identification or credit card, inserting the gripped identification or credit card into the sleeve or window through a side opening in the sleeve or window so that the gripping element extends out of the side opening to form a removal means for the identification or credit card from the sleeve or window.

20. A method of manufacturing the element of claim 1 comprising:
a) providing a sheet of support film having only one face that is coated with pressure-sensitive adhesive and a second uncoated face;
b) adhering a sheet of gripping material along a line on the second face of the support film;
c) folding the gripping material and the sheet of support film so that the opposed surfaces are formed; and
d) cutting both the gripping element and the opposed surfaces to form individual elements.

21. A removable and positionable gripping element for attaching to cards comprising:
a) two opposed surfaces having pressure-sensitive adhesive on the opposed surfaces;
b) at least one of the opposed surfaces being translucent or transparent and having a length of between 5 and 60 millimeters;
c) the two opposed surfaces being joined at a top end;
d) attached to the top end of the two opposed surfaces at a point of attachment is a gripping element between 4 and 40 millimeters; and
e) the point of attachment being flexible.
